(19) United States
(12) Patent Application Publication
(10) Pub. No.: US 2023/0235536 A1
(43) Pub. Date: Jul. 27, 2023

(54) DAMPING SYSTEM FOR MOVABLE ARM OF LOADING MACHINE AND OPERATION MACHINERY

(71) Applicant: Shanghai Sany Heavy Machinery Co., Ltd., Shanghai (CN)

(72) Inventors: Lichun MA, Shanghai (CN); Zida LIU, Shanghai (CN); Weian JIANG, Shanghai (CN)

(73) Assignee: Shanghai Sany Heavy Machinery Co., Ltd., Shanghai (CN)

(21) Appl. No.: 18/192,995

(22) Filed: Mar. 30, 2023

Related U.S. Application Data
(63) Continuation of application No. PCT/CN2021/141660, filed on Dec. 27, 2021.

(30) Foreign Application Priority Data
Jan. 29, 2021 (CN) 202110129408.9

(51) Int. Cl. E02F 9/22; F15B 21/00; F15B 1/04; F15B 13/044; F15B 11/08

(52) U.S. Cl. CPC E02F 9/2207; F15B 21/008; F15B 1/04; F15B 13/044; F15B 11/08; E02F 9/2267; E02F 9/2217; E02F 9/2271; E02F 9/2285

(57) ABSTRACT

Disclosed are a damping system for a movable arm of a loading machine and an operation machinery, which comprise a multi-way valve, a movable arm oil cylinder, a movable arm damping valve, and a damping lock. The multi-way valve comprises a movable arm valve core and a bucket valve core, a first movable arm oil port of the movable arm valve core communicates with a rod cavity of the movable arm oil cylinder, a second movable arm oil port of the movable arm valve core communicates with a rodless cavity of the movable arm oil cylinder, the rod cavity of the movable arm oil cylinder communicates with the movable arm damping valve, the rodless cavity of the movable arm oil cylinder communicates, via the damping lock, with the movable arm damping valve; a switching oil port of the damping lock communicates with an unloading position of the bucket valve core.

### CROSS-REFERENCE TO RELATED APPLICATIONS

The present application is a continuation of International Application No. PCT/CN2021/141660, filed on Dec. 27, 2021, which claims priority to Chinese patent application No. 202110129408.9, filed on Jan. 29, 2021, entitled “A damping system for a movable arm of a loading machine and an operation machinery”. All of the aforementioned applications are incorporated herein by reference in their entireties.

### TECHNICAL FIELD

The present application relates to the technical field of operation machinery, and specifically to a damping system for a movable arm of a loading machine and an operation machinery.

### BACKGROUND

A loading machine has a rigid connection between the wheel edge support and the vehicle frame. When the loading machine is running on an uneven road, the whole vehicle will sway with the front axle as the center which sometimes may cause the rear axle to leave the ground. In this case, the driver's body will sway with the whole vehicle, resulting in poor driving comfort. As operation devices, heavy matters and other parts of the machine will react to the bumping bottom or obstacles, strong vibration and impact occur, causing materials in the bucket to fall out and affecting the operation efficiency. In order to reduce vibration during running and improve driving comfort and operation efficiency, more and more loading machines are provided with movable arm damping function.

During operation of bucket loading of the loading machine, it is required that the movable arm damping function is in the disabled state. When the loading machine is transferred for a long distance, the movable arm damping function is enabled to reduce bumping of the whole machine and increase running speed. The movable arm damping function is such that the pressure pulse and flow fluctuation of the large cavity of the movable arm oil cylinder are absorbed by the energy accumulator, adjusting the stroke of the piston rod, reducing the amplitude of vertical fluctuation of the gravity center of the bucket, and thus eliminating bumping of the whole machine. Therefore, the damping effect of the whole machine is determined by the internal oil liquid pressure and volume of the energy accumulator.

### SUMMARY

In the present application, a damping system for a movable arm of a loading machine is provided, to solve the problem of significant decrease in bucket level/height due to bucket unloading and pressing downward on the movable arm mechanism.

In the present application, a damping system for a movable arm of a loading machine is provided, comprising: a multi-way valve, a movable arm oil cylinder, a movable arm damping valve, and a damping lock; the multi-way valve comprises a movable arm valve core and a bucket valve core, wherein a first movable arm oil port of the movable arm valve core is configured to communicate with a rod cavity of the movable arm oil cylinder, a second movable arm oil port of the movable arm valve core is configured to communicate with a rodless cavity of the movable arm oil cylinder, the rod cavity of the movable arm oil cylinder is configured to communicate with the movable arm damping valve, and the rodless cavity of the movable arm oil cylinder is configured to communicate, via the damping lock, with the movable arm damping valve; wherein the damping lock has a damping connection position and a damping disconnection position, and a switching oil port of the damping lock is configured to communicate with an unloading position of the bucket valve core such that when a pressure at the switching oil port of the damping lock reaches a preset pressure, the damping lock switches from the damping connection position to the damping disconnection position.

According to the damping system for a movable arm of a loading machine, the damping system for a movable arm of a loading machine further comprises an energy accumulator and an oil tank; the energy accumulator is configured to communicate, via the movable arm damping valve, with the movable arm oil cylinder, and maintain a constant pressure of supplying oil; the oil tank is configured to communicate with the movable arm damping valve, the movable arm valve core and the bucket valve core, and supply oil.

According to the damping system for a movable arm of a loading machine, the movable arm damping valve comprises: a damping valve core; the damping valve core is provided with a first damping oil port for connecting the rod cavity of the movable arm oil cylinder with the oil tank and a second damping oil port for connecting the rodless cavity of the movable arm oil cylinder with the energy accumulator.

According to the damping system for a movable arm of a loading machine, the damping valve core is provided with a fourth working position for connection of the first damping oil port and connection of the second damping oil port, a first working position for connection of the second damping oil port and disconnection of the first damping oil port, and a second working position for disconnection of the first damping oil port and disconnection of the second damping oil port.

According to the damping system for a movable arm of a loading machine, the damping valve core further has a third working position for connecting the energy accumulator and the oil tank.

According to the damping system for a movable arm of a loading machine, the movable arm damping valve further comprises a one-way throttle valve group and a solenoid directional valve; a switching oil port of the damping valve core is configured to communicate, via the one-way throttle valve group, with the solenoid directional valve, and the solenoid directional valve has with two working positions for connecting or disconnecting the rodless cavity of the movable arm oil cylinder and the energy accumulator.

According to the damping system for a movable arm of a loading machine, the movable arm damping valve further comprises an overflow valve; the first damping oil port is configured to communicate, via the overflow valve, with the energy accumulator, and the overflow valve is used for limiting the pressure of the energy accumulator.

According to the damping system for a movable arm of a loading machine, the movable arm damping valve further comprises a switch valve; the second damping oil port is configured to communicate, via the switch valve, with the first damping oil port, the switch valve has a connection position for communicating the first damping oil port and the second damping oil port, and a disconnection position for disconnecting the first damping oil port and the second damping oil port.

According to the damping system for a movable arm of a loading machine, the damping system for a movable arm of a loading machine further comprises: a bucket oil cylinder; a first oil port of the bucket valve core is configured to communicate with a rod cavity of the bucket oil cylinder, and a second oil port of the bucket valve core is configured to communicate with a rodless cavity of the bucket oil cylinder; if the switching oil port of the damping lock is in communication with the rod cavity of the bucket oil cylinder and the switching oil port of the damping lock is not in communication with the rodless cavity of the bucket oil cylinder, the damping lock is able to switch from the damping connection position to the damping disconnection position when the pressure at the switching oil port of the damping lock reaches a preset pressure.

In the present application, an operation machinery is further provided. The operation machinery comprises the damping system for a movable arm of a loading machine which comprises: a multi-way valve, a movable arm oil cylinder, a movable arm damping valve and a damping lock; the multi-way valve comprises a movable arm valve core and a bucket valve core, wherein a first movable arm oil port of the movable arm valve core is configured to communicate with a rod cavity of the movable arm oil cylinder, a second movable arm oil port of the movable arm valve core is configured to communicate with a rodless cavity of the movable arm oil cylinder, the rod cavity of the movable arm oil cylinder is configured to communicate with the movable arm damping valve, and the rodless cavity of the movable arm oil cylinder is configured to communicate, via the damping lock, with the movable arm damping valve; wherein the damping lock has a damping connection position and a damping disconnection position, and a switching oil port of the damping lock is configured to communicate with an unloading position of the bucket valve core such that when a pressure at the switching oil port of the damping lock reaches a preset pressure, the damping lock switches from the damping connection position to the damping disconnection position.

In the damping system for a movable arm of a loading machine and the operation machinery as provided in the present application, by adding the damping lock having the damping connection position and the damping disconnection position and using the damping lock to connect the rodless cavity of the movable arm oil cylinder with the movable arm damping valve and to connect the switching oil port of the damping lock with the unloading position of the bucket valve core, the damping lock is controlled by a pilot pressure of the unloading position such that when a pressure at the switching oil port of the damping lock reaches a preset pressure, the damping lock switches from the damping connection position to the damping disconnection position, effectively solving the problem of significant decrease in bucket level/height due to bucket unloading and pressing downward on the movable arm mechanism.

### BRIEF DESCRIPTION OF THE DRAWINGS

In order to explain the technical solutions in the present application or prior art more clearly, the figures necessary to be used in the description of the embodiments or prior art will be briefly introduced hereinafter. Obviously, the figures used in the description as below are for some embodiments of the present application, and based on these figures, those skilled in the art can obtain other figures without any inventive work.

FIG. 1 is a structural diagram of an existing damping system for a movable arm.

FIG. 2 is a structural diagram of a damping system for a movable arm as provided in the present application.

FIG. 3 is a structural diagram of a damping valve core as provided in the present application.

FIG. 4 is a structural diagram of a movable arm damping valve as provided in the present application.

### DETAILED DESCRIPTION OF THE EMBODIMENTS

In order to make the purposes, technical solutions and advantages of the present application clearer, hereinafter, the technical solutions in the present application will be described clearly and completely in combination with the accompanying drawings in the present invention. Obviously, the described embodiments are some embodiments of the present application, rather than all embodiments. Any other embodiments obtained by those skilled in the art, based on the embodiments of the present application and without any inventive work, will fall within the protection scope of the present application.

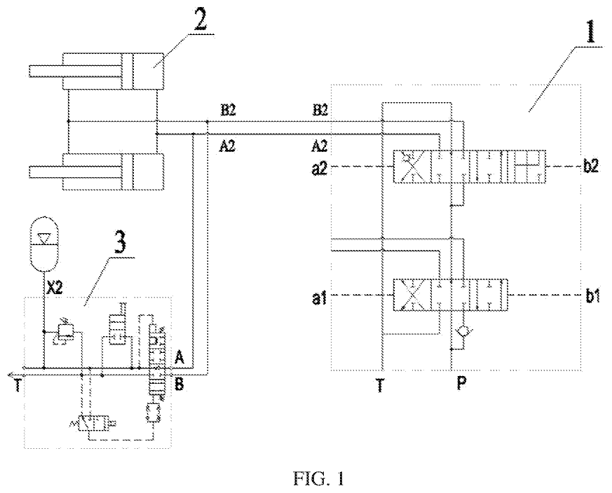

There are two filling manners for the prior energy accumulator: 1) connecting the oil port of the large cavity of the movable arm oil cylinder directly with the oil port of the energy accumulator and filling the energy accumulator by the large cavity of the movable arm oil cylinder (see FIG. 1), wherein when the oil liquid pressure in the energy accumulator reaches a preset value, the movable arm damping valve 3 disconnects the connection between the oil port of the large cavity of the movable arm oil cylinder 2 and the oil port of the energy accumulator; 2) connecting the oil port of the energy accumulator, via a hydraulically or electronically controlled reversing valve, with the oil inlet of the multi-way valve 1 (i.e. pumping source), wherein when the pressure of the pumping source is higher than the oil liquid pressure of the energy accumulator, the pumping source performs filling to the energy accumulator.

When the movable arm damping valve 3 uses a manner of filling the energy accumulator by the large cavity of the movable arm oil cylinder 2, the bucket unloads material and presses downward on the movable arm mechanism, the movable arm oil cylinder 2 will significantly retract to cause significant decrease in bucket level/height, resulting in danger for loading.

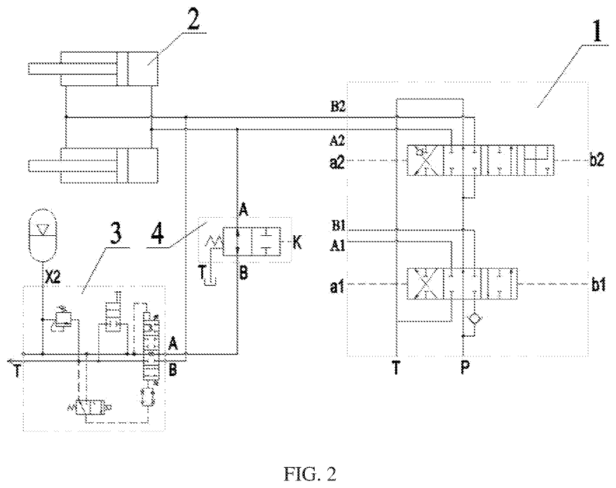

Hereinafter, a damping system for a movable arm of a loading machine as provided in the present application will be described in combination with FIG. 2. The damping system for a movable arm of a loading machine comprises: a multi-way valve 1, a movable arm oil cylinder 2, a movable arm damping valve 3 and a damping lock 4. The multi-way valve 1 comprises: a movable arm valve core and a bucket valve core. A first movable arm oil port B2 of the movable arm valve core is configured to communicate with a rod cavity of the movable arm oil cylinder 2, a second movable arm oil port A2 of the movable arm valve core is configured to communicate with a rodless cavity of the movable arm oil cylinder 2, the rod cavity of the movable arm oil cylinder 2 is configured to communicate with the movable arm damping valve 3, and the rodless cavity of the movable arm oil cylinder 2 is configured to communicate, via the damping lock 4, with the movable arm damping valve 3.

Herein, the damping lock 4 has a damping connection position and a damping disconnection position, and a switching oil port K of the damping lock 4 is configured to communicate with an unloading position b1 of the bucket valve core such that when a pressure of the switching oil port K of the damping lock 4 reaches a preset pressure, the damping lock 4 switches from the damping connection position to the damping disconnection position.

In the present embodiment, the damping system for a movable arm of a loading machine further comprises an energy accumulator X2 and an oil tank; the energy accumulator X2 is configured to communicate, via the movable arm damping valve 3, with the movable arm oil cylinder 2, and is used for maintaining a constant oil supply pressure. The oil tank is configured to communicate with the movable arm damping valve, the movable arm valve core and the bucket valve core. The oil tank is connected with a pipeline T in FIG. 2 and is driven by an oil pump to control oil supply of the whole damping system for a movable arm of a loading machine.

During operation of the damping system for a movable arm of a loading machine, after the operator turns off a movable arm damping button, the movable arm damping valve 3 is off. During operation of bucket loading, the pressure in the rodless cavity of the movable arm oil cylinder 2 increases and the oil liquid in the movable arm oil cylinder 2 will flow through the movable arm damping valve 3 to the energy accumulator X2, and such process is called energy accumulator filling. When the pressure in the rodless cavity of the movable arm oil cylinder 2 is higher than 12.5 MPa, the movable arm damping valve 3 disconnects the oil way connection between the rodless cavity of the movable arm oil cylinder 2 and the energy accumulator, and the movable arm damping function is in the disabled state at this time.

After the operator turns on the movable arm damping button, the movable arm damping valve 3 is on. When the bucket does not unload, there is no pressure at the switching oil port K of the damping lock 4, the damping lock 4 is in the damping connection position, the oil port of the damping lock 4 is connected, the rodless cavity of the movable arm oil cylinder 2 communicates with the oil port of the damping lock 4, the energy accumulator X2 communicates, via the movable arm damping valve 3, with the oil port of the damping lock 4, the rodless cavity of the movable arm oil cylinder 2 communicates, via the movable arm damping valve 3, with the oil tank, and the movable arm damping function is in the enabled state at this time. When the bucket unloads, there is a control pressure at the switching oil port K of the damping lock 4, the damping lock 4 is in the damping disconnection position, the oil port of the damping lock 4 is disconnected, the oil way between the rodless cavity of the movable arm oil cylinder 2 and the energy accumulator X2 is cut off by the damping lock 4, and the rodless cavity of the movable arm oil cylinder 2 communicates only with the second movable arm oil port A2 of the multi-way valve 1. At this time, the movable arm valve core of the multi-way valve 1 is in the closed state, when the bucket unloads material and presses downward on the movable arm mechanism, the movable arm oil cylinder 2 will not retract.

In the damping system for a movable arm of a loading machine as provided in the present application, by adding the damping lock having the damping connection position and the damping disconnection position and using the damping lock to connect the rodless cavity of the movable arm oil cylinder with the movable arm damping valve and to connect the switching oil port of the damping lock with the unloading position of the bucket valve core, the damping lock is controlled by a pilot pressure of the unloading position such that when a pressure of the switching oil port of the damping lock reaches a preset pressure, the damping lock switches from the damping connection position to the damping disconnection position, effectively solving the problem of significant decrease in bucket level/height due to bucket unloading and pressing downward on the movable arm mechanism, and ensuring stable operation of the damping system for a movable arm of a loading machine.

As shown in FIGS. 2-4, the movable arm damping valve comprises a damping valve core 33. The damping valve core 33 is provided with a first damping oil port B for connecting the rod cavity of the movable arm oil cylinder 2 with the oil tank and a second damping oil port A for connecting the rodless cavity of the movable arm oil cylinder 2 with the energy accumulator X2.

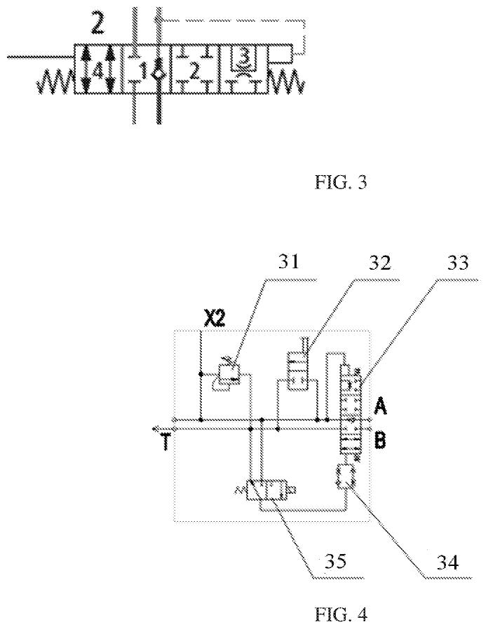

As shown in FIG. 3, the damping valve core 33 has a first working position for connection of the second damping oil port and disconnection of the first damping oil port, a second working position for disconnection of the first damping oil port and disconnection of the second damping oil port, and a fourth working position for connection of the first damping oil port and connection of the second damping oil port.

In addition, when the pressure of the rodless cavity of the movable arm oil cylinder 2 is further increased, a third working position can be added in the damping valve core 33 for connecting the energy accumulator X2 with the oil tank, the energy accumulator X2 communicates with the oil tank , the oil way pressure can be balanced.

After the operator turns off the movable arm damping button, the movable arm damping valve 3 is off, and the damping valve core 33 is in the first working position at this time. During operation of bucket loading, the pressure in the rod cavity of the movable arm oil cylinder 2 increases and the oil liquid in the movable arm oil cylinder 2 will flow through the movable arm damping valve 3 to the energy accumulator X2, and such process is called energy accumulator filling. When the pressure in the rod cavity of the movable arm oil cylinder 2 is higher than 12.5 MPa, the damping valve core 33 is moved to the second working position, and the movable arm damping valve 3 cuts off the oil way connection between the rodless cavity of the movable arm oil cylinder 2 and the energy accumulator, and the movable arm damping function is in the disabled state at this time.

After the operator turns on the movable arm damping button, the movable arm damping valve 3 is on, the damping valve core 33 moves to the fourth working position. When the bucket does not unload, there is no pressure at the switching oil port K of the damping lock 4, the damping lock 4 is in the damping connection position, the oil port of the damping lock 4 is connected, the rodless cavity of the movable arm oil cylinder 2 communicates with the oil port of the damping lock 4, the energy accumulator X2 communicates, via the movable arm damping valve 3, with the oil port of the damping lock 4, the rodless cavity of the movable arm oil cylinder 2 communicates, via the movable arm damping valve 3, with the oil tank, and the movable arm damping function is in the enabled state at this time. When the bucket unloads, there is a control pressure at the switching oil port K of the damping lock 4, the damping lock 4 is in the damping disconnection position, the oil port of the damping lock 4 is disconnected, the oil way between the rodless cavity of the movable arm oil cylinder 2 and the energy accumulator X2 is cut off by the damping lock 4, and the rodless cavity of the movable arm oil cylinder 2 communicates only with the second movable arm oil port A2 of the multi-way valve 1. At this time, the movable arm valve core of the multi-way valve 1 is in the closed state, when the bucket unloads material and presses downward on the movable arm mechanism, the movable arm oil cylinder 2 will not retract.

In the present embodiment, the movable arm damping valve further comprises: a one-way throttle valve group 34 and a solenoid directional valve 35. A switching oil port of the damping valve core 33 is configured to communicate, via the one-way throttle valve block 34, with the solenoid directional valve 35. The solenoid directional valve 35 has two working positions for connecting or disconnecting the rodless cavity of the movable arm oil cylinder 2 with the energy accumulator X2. The one-way throttle valve group 34 is used for stable switching of the damping valve core 33. After the solenoid directional valve 35 receives a signal of the movable arm damping button, the movable arm damping function is enabled, and the damping valve core 33 is controlled by the control pressure for connection and disconnection between the rodless cavity of the movable arm oil cylinder 2 and the energy accumulator.

Herein, the energy accumulator X2 may be further provided with an overflow valve 31. The first damping oil port B is configured to communicate, via the overflow valve 31, with the energy accumulator X2, and thus the overflow valve 31 is used for limiting the pressure of the energy accumulator X2.

In order to facilitate releasing pressure in the energy accumulator X2 after machine is shutdown, the movable arm damping valve further comprises a switch valve 32. The second damping oil port A is configured to communicate, via the switch valve 32, with the first damping oil port B, the switch valve 32 has a connection position for connecting the first damping oil port B and the second damping oil port A, and a disconnection position for disconnecting the first damping oil port B and the second damping oil port A.

The switching of the damping lock 4 may be controlled by other pressures, such as the rod cavity pressure of the bucket oil cylinder can be used ,to switch the damping lock 4. The bucket oil cylinder is similar in structure to the movable arm oil cylinder. The first oil port B1 of the bucket valve core is configured to communicate with the rod cavity of the bucket oil cylinder, and the second oil port Al of the bucket valve core is configured to communicate with the rodless cavity of the bucket oil cylinder. If the switching oil port of the damping lock 4 is in communication with the rod cavity of the bucket oil cylinder and the switching oil port of the damping lock 4 is not in communication with the rodless cavity of the bucket oil cylinder, the damping lock 4 is able to switch from the damping connection position to the damping disconnection position when the pressure at the switching oil port K of the damping lock 4 reaches a preset pressure.

It is understandable that the preset pressure at the switching oil port K of the damping lock 4 may be adjusted according to actual conditions. When the damping lock 4 is controlled by a pilot pressure of the unloading position, the preset pressure of the damping lock 4 is 5.0˜8.0 bar. When it is controlled by the rod cavity pressure of the bucket oil cylinder, the preset pressure is 50.0˜80.0 bar.

In the present application, an operation machinery is further provided. The operation machinery may be an excavator, a pumping vehicle, a crane or other devices. The operation machinery comprises the damping system for a movable arm of a loading machine. As shown in FIGS. 2-4, the damping system for a movable arm of a loading machine comprises: a multi-way valve 1, a movable arm oil cylinder 2, a movable arm damping valve 3 and a damping lock 4. The multi-way valve 1 comprises: a movable arm valve core and a bucket valve core. A first movable arm oil port B2 of the movable arm valve core is configured to communicate with a rod cavity of the movable arm oil cylinder 2, a second movable arm oil port A2 of the movable arm valve core is configured to communicate with a rodless cavity of the movable arm oil cylinder 2, the rod cavity of the movable arm oil cylinder 2 is configured to communicate with the movable arm damping valve 3, the rodless cavity of the movable arm oil cylinder 2 is configured to communicate, via the damping lock 4, with the movable arm damping valve 3. Herein, the damping lock 4 has a damping connection position and a damping disconnection position, a switching oil port K of the damping lock 4 is configured to communicate with an unloading position b 1 of the bucket valve core such that when a pressure of the switching oil port K of the damping lock 4 reaches a preset pressure, the damping lock 4 switches from the damping connection position to the damping disconnection position.

During operation of the operation machinery, after the operator turns off a movable arm damping button, the movable arm damping valve 3 is off. During operation of bucket loading, the pressure in the rod cavity of the movable arm oil cylinder 2 increases and the oil liquid in the movable arm oil cylinder 2 will flow through the movable arm damping valve 3 to the energy accumulator X2, and such process is called energy accumulator filling. When the pressure in the rod cavity of the movable arm oil cylinder 2 is higher than 12.5 MPa, the movable arm damping valve 3 cuts off the oil way connection between the rodless cavity of the movable arm oil cylinder 2 and the energy accumulator, and the movable arm damping function is in the disabled state at this time.

After the operator turns on the movable arm damping button, the movable arm damping valve 3 is on. When the bucket does not unload, there is no pressure at the switching oil port K of the damping lock 4, the damping lock 4 is in the damping connection position, the oil port of the damping lock 4 is connected, the rodless cavity of the movable arm oil cylinder 2 communicates with the oil port of the damping lock 4, the energy accumulator X2 communicates, via the movable arm damping valve 3, with the oil port of the damping lock 4, the rodless cavity of the movable arm oil cylinder 2 communicates, via the movable arm damping valve 3, with the oil tank, and the movable arm damping function is in the enabled state at this time. When the bucket unloads, there is a control pressure at the switching oil port K of the damping lock 4, the damping lock 4 is in the damping disconnection position, the oil port of the damping lock 4 is disconnected, the oil way between the rodless cavity of the movable arm oil cylinder 2 and the energy accumulator X2 is cut off by the damping lock 4, and the rodless cavity of the movable arm oil cylinder 2 communicates only with the second movable arm oil port A2 of the multi-way valve 1. At this time, the movable arm valve core of the multi-way valve 1 is in the closed state, when the bucket unloads material and presses downward on the movable arm mechanism, the movable arm oil cylinder 2 will not retract.

The operation machinery, as provided in the present application, is provided with the damping system for a movable arm of a loading machine as described above, by adding the damping lock having the damping connection position and the damping disconnection position and using the damping lock to connect the rodless cavity of the movable arm oil cylinder with the movable arm damping valve and to connect the switching oil port of the damping lock with the unloading position of the bucket valve core, the damping lock is controlled by a pilot pressure of the unloading position such that when a pressure of the switching oil port of the damping lock reaches a preset pressure, the damping lock switches from the damping connection position to the damping disconnection position, effectively solving the problem of significant decrease in bucket level/height due to bucket unloading and pressing downward on the movable arm mechanism, and ensuring stable operation of the damping system for a movable arm of a loading machine.

Finally, it should be noted that the above embodiments are only used for explaining, rather than limiting, the technical solutions of the present application. Though the present application has been explained in detail in combination with the above embodiments, it should be understood by those skilled in the art that the technical solutions as recorded in the above embodiments can be modified or some technical features therein can be substituted equivalently. For such modification or substitution, the technical solutions corresponding thereto will not substantially depart from the spirit and scope of the technical solutions of the embodiments in the present application.

What is claimed is:

1. A damping system for a movable arm of a loading machine, comprising: a multi-way valve, a movable arm oil cylinder, an energy accumulator, an oil tank, a movable arm damping valve and a damping lock; wherein
the multi-way valve comprises a movable arm valve core and a bucket valve core, the movable arm damping valve comprises a damping valve core with a first damping oil port and a second damping oil port; a first movable arm oil port of the movable arm valve core is configured to communicate with a rod cavity of the movable arm oil cylinder, a second movable arm oil port of the movable arm valve core is configured to communicate with a rodless cavity of the movable arm oil cylinder, the rod cavity of the movable arm oil cylinder is configured to communicate, via the first damping oil port, with the oil tank , and the rodless cavity of the movable arm oil cylinder is configured to communicate , via the damping lock and the second damping oil port , with the energy accumulator;
the damping lock has a damping connection position and a damping disconnection position, and a switching oil port of the damping lock is configured to communicate with an unloading position of the bucket valve core such that when a pressure at the switching oil port of the damping lock reaches a preset pressure, the damping lock switches from the damping connection position to the damping disconnection position.

2. The damping system for a movable arm of a loading machine according to claim 1, wherein the oil tank is configured to communicate with the movable arm damping valve, the movable arm valve core and the bucket valve core, and supply oil.

3. The damping system for a movable arm of a loading machine according to claim 2, wherein the damping valve core has a fourth working position for connection of the first damping oil port and connection of the second damping oil port, a first working position for connection of the second damping oil port and disconnection of the first damping oil port, and a second working position for disconnection of the first damping oil port and disconnection of the second damping oil port.

4. The damping system for a movable arm of a loading machine according to claim 3, wherein the damping valve core further has a third working position for connecting the energy accumulator and the oil tank.

5. The damping system for a movable arm of a loading machine according to claim 1, wherein the movable arm damping valve further comprises a one-way throttle valve group and a solenoid directional valve;
a switching oil port of the damping valve core is configured to communicate, via the one-way throttle valve group, with the solenoid directional valve, and the solenoid directional valve has two working positions for connecting or disconnecting the rodless cavity of the movable arm oil cylinder and the energy accumulator.

6. The damping system for a movable arm of a loading machine according to claim 1, wherein the movable arm damping valve further comprises an overflow valve; the first damping oil port is configured to communicate, via the overflow valve, with the energy accumulator, and the overflow valve is used for limiting the pressure of the energy accumulator.

7. The damping system for a movable arm of a loading machine according to claim 1, wherein the movable arm damping valve further comprises a switch valve;
the second damping oil port is configured to communicate, via the switch valve, with the first damping oil port, the switch valve has a connection position for connecting the first damping oil port and the second damping oil port, and a disconnection position for disconnecting the first damping oil port and the second damping oil port.

8. The damping system for a movable arm of a loading machine according to claim 1, further comprising: a bucket oil cylinder; wherein
a first oil port of the bucket valve core is configured to communicate with a rod cavity of the bucket oil cylinder, and a second oil port of the bucket valve core is configured to communicate with a rodless cavity of the bucket oil cylinder;
if the switching oil port of the damping lock is in communication with the rod cavity of the bucket oil cylinder and the switching oil port of the damping lock is not in communication with the rodless cavity of the bucket oil cylinder, the damping lock is able to switch from the damping connection position to the damping disconnection position when the pressure at the switching oil port of the damping lock reaches a preset pressure.

9. An operation machinery, comprising the damping system for a movable arm of a loading machine according to claim 1.

10. The operation machinery according to claim 9, wherein the oil tank is configured to communicate with the movable arm damping valve, the movable arm valve spool and the bucket valve spool, and is used for oil supply.

11. The operation machinery according to claim 10, wherein the damping valve spool has a fourth working position for connection of the first damping oil port and connection of the second damping oil port, a first working position for connection of the second damping oil port and disconnection of the first damping oil port, and a second working position for disconnection of the first damping oil port and disconnection of the second damping oil port.

12. The operation machinery according to claim 11, wherein the damping valve spool further has a third working position for connecting the energy accumulator and the oil tank.

13. The operation machinery according to claim 9, wherein the movable arm damping valve further comprises a one-way throttle valve group and a solenoid directional valve;
a switching oil port of the damping valve spool is configured to communicate, via the one-way throttle valve group, with the solenoid directional valve, and the solenoid directional valve has two working positions for connecting or disconnecting the rodless cavity of the movable arm oil cylinder and the energy accumulator.

14. The operation machinery according to claim 9, wherein the movable arm damping valve further comprises an overflow valve; the first damping oil port is configured to communicate, via the overflow valve, with the energy accumulator, and the overflow valve is used for limiting the pressure of the energy accumulator.

15. The operation machinery according to claim 9, wherein the movable arm damping valve further comprises a switch valve;
the second damping oil port is configured to communicate, via the switch valve, with the first damping oil port, the switch valve has a connection position for connecting the first damping oil port and the second damping oil port, and a disconnection position for disconnecting the first damping oil port and the second damping oil port.

16. The operation machinery according to claim 9, wherein the damping system for a movable arm of a loading machine further comprises a bucket oil cylinder;
a first oil port of the bucket valve spool is configured to communicate with a rod cavity of the bucket oil cylinder, and a second oil port of the bucket valve spool is configured to communicate with a rodless cavity of the bucket oil cylinder;
if the switching oil port of the damping lock is in communication with the rod cavity of the bucket oil cylinder and the switching oil port of the damping lock is not in communication with the rodless cavity of the bucket oil cylinder, the damping lock is able to switch from the damping connection position to the damping disconnection position when the pressure at the switching oil port of the damping lock reaches a preset pressure.
